(19) United States
(12) Patent Application Publication
(10) Pub. No.: US 2011/0296325 A1
(43) Pub. Date: Dec. 1, 2011

(54) METHOD AND APPARATUS FOR USER INTERFACE DISPLAY

(75) Inventor: Brian Orr, Cambridge (CA)

(73) Assignee: Sony Corporation, Tokyo (JP)

(21) Appl. No.: 12/791,744

(22) Filed: Jun. 1, 2010

(51) Int. Cl. G06F 3/048

(52) U.S. Cl. 715/764

(57) ABSTRACT

A device and methods are provided for operating a computing device to display a user interface for an application. In one embodiment a method includes executing code of an application program stored in the memory to display a user interface on the computing device, and detecting a display command in the code for an element of the user interface during execution of the application program, wherein the display command identifies a format identifier for the element. The method further includes determining one or more display characteristics of the element based on the format identifier, wherein the code includes a format identifier table defining one or more display characteristics of the format identifier, and displaying the element by the computing device, wherein display includes data from the display command based on characteristics of the format identifier determined from the format identifier table.

### FIELD OF THE INVENTION

The present invention relates generally to application including a user interface and more particularly to displaying elements of a user interface.

### BACKGROUND OF THE INVENTION

Traditional methods of programming and displaying user interfaces for applications typically require programmers to code visual characteristics and styles of an application during programming. In addition, applications developed for some operating systems (e.g., Windows applications written in Win32 in C++) require many steps to be performed by the programmer to draw an element. However, elements and characteristics of a user interface elements generally change during development. Thus, introducing changes based on conventional methods of coding requires changes to code of the application. Further, due to these modes of coding, incorporating changes can be difficult and may be costly.

An example of coding according to the conventional modes of programming is depicted in FIG. 1. Specifically, FIG. 1 depicts an example of drawing a brush command. Brush 100 is depicted as having a rectangular outline 105 and colored fill 110 (shown as gray). Based on the conventional modes of programming, each element of brush 100 must be specified with the command to draw the brush or paint. An example of coding according to the conventional modes of programming may be performed as follows:

i) HBRUSH hBrush=CreateSolidBrush(RGB(128,128,128));

ii) SelectObject(hDC, hBrush);

iii) Rectangle(hDC, rect.left,rect.top,rect.right,rect.bottom);

The first line of the code represents making a gray brush, similar to brush 100. The second line relates to selecting the object (e.g., the brush), and the third line represents drawing a filled rectangle (e.g., within outline 105). One drawback of the aforementioned approach is that the coding format of the operating platform assumes a solid color fill. As a result, the fill of the object, fill 110 for example, will not be modified without a change to code of the application, a more particularly a change to the brush command. The operating system, for example, employs a separate command for providing fill to an object such as 100. Another drawback of the above-identified approach is that the color of the fill must be hard coded; it must be set by the programmer either as a solid color or a specific operating system color. Further, modification of the user interface may be made more difficult as the elements must be changed in the code. This in turn makes it difficult for graphic artists to modify the work of the programmer.

As will be discussed in more detail below, programming restrictions due to requirements of the conventional application programming interfaces of operating platforms thus require many steps for programming a window, or element of a user interface.

One conventional approach to displaying user interfaces includes inheritance of features from one or more elements based on a hierarchy. For example, web applications may include inheritance of one or more display features. One drawback of web based interfaces is due to the nature of loading data. Operating platforms typically refresh data continuously, wherein elements of web applications are typically loaded once to render a static page. Certain elements of the page may animate using predefined scripts, but overall the website is parsed once. Accordingly, any changes to the website (HTML) require the HTML code to be re-parsed, which requires significant time (e.g. 100 ms-500 ms). In contrast, repainting a window of a user interface for an operating system should be performed on the order of 1-5 ms. Thus, conventional web based approaches for displaying user interfaces do not allow for operating system functions which require constant repainting when a paint message or display command is received.

Thus, what is required is a method and device for facilitating the programming process which can assist in development allows for efficient display of one or more user interface elements.

### BRIEF SUMMARY OF THE INVENTION

Disclosed and claimed herein are a device and method for operating a computing device having a processor and a memory storing code to display a user interface for an application. In one embodiment, a method includes executing, by the processor, code of an application program stored in the memory to display a user interface on the computing device, and detecting a display command in the code for an element of the user interface during execution of the application program, wherein the display command identifies a format identifier for the element. The method further includes determining one or more display characteristics of the element based on the format identifier, wherein the code includes a format identifier table defining one or more display characteristics of the format identifier, and displaying the element by the computing device, wherein display includes data from the display command based on the one or more characteristics of the format identifier determined from the format identifier table.

Other aspects, features, and techniques of the invention will be apparent to one skilled in the relevant art in view of the following detailed description of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a graphical representation of paint command according to prior art;

FIG. 2 depicts a graphical representation of a display element according to one embodiment of the invention;

FIG. 3 depicts a graphical representation for display of user interface elements according to one or more embodiments of the invention;

FIG. 4 depicts a simplified block diagram of computing device according to one embodiment of the invention;

FIG. 5 depicts a process for displaying one or more elements of a user interface according to one or more embodiments of the invention;

FIGS. 6A-6B depict a graphical representations of user interface elements according to one embodiment of the invention;

FIG. 7 depicts a graphical representation of user interface elements according to one embodiment of the invention; and

FIG. 8 depicts another process for displaying one or more elements of a user interface according to one or more embodiments of the invention.

### DETAILED DESCRIPTION OF THE EXEMPLARY EMBODIMENTS

### Overview and Terminology

One aspect of the present invention relates to displaying elements of a user interface. In one embodiment, an application may be coded to include one or more format identifiers, wherein display commands of the application may be based on a format identifier. As described herein, a format identifier relates to a coded description of one or more characteristics of a user interface element. Elements of a user interface may be associated with one or more format identifiers. Similarly a format identifier may be associated with one or more elements. Format identifiers may additionally be defined during development of an application. Format identifiers may be employed to provide display characteristics, such as font, text, background format, color, image, graphic style, fill color, outline style, and/or shape of user interface elements. Format identifier characteristics may further include one or more of formatting, spacing, position, position relative to another element, position'relative to a format identifier, and arrangement of the element for execution with the operating platform. According to another embodiment, the code of an application may include a format identifier table to define one or more characteristics of the format identifier. In that fashion, one or more visual attributes of the application may be modified via the format identifier table without changing code of the application.

In another embodiment, a process is provided for displaying one or more elements of a user interface. The process may include determining one or more display characteristics of a user interface element during the execution of an application. In one embodiment, the process may be configured to display one or more elements of the application based on a format identifier associated with a display command. Characteristics of the format identifier may be determined from a format identifier table. In another embodiment, the process may employ an application programming interface (API) for determining one or more characteristics from the format identifier table during execution of the code. According to another embodiment, operation of the process may be performed to allow for detection and processing of display (e.g., paint, brush, etc) commands a plurality of times during execution of the application. According to another embodiment, a device is provided to provide a user interface based on one or more format identifiers in an application executed by the device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

Referring now to the figures, FIG. 2 depicts a graphical representation of a user interface element according to one embodiment of the invention. User interface element 200 relates to a display element of an application, the display of which may be based on a command of the application. Alternatively, or in combination, display of the user interface element 200 may be based on one or more format identifiers. Display of user interface element 200 as described herein may avoid one or more drawbacks of conventional methods for programming, modifying, and display of user interface elements. Further, programming of user interface elements, such as user interface element 200, may be facilitated by an application programming interface (API) to indirectly draw one or more elements of the user interface element.

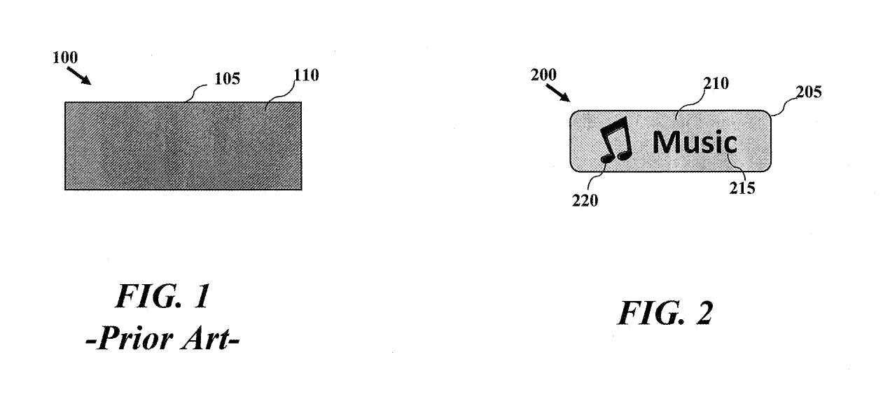

As depicted, user interface element 200 includes border 205, fill 210, text 215, and symbol 220. In contrast with the conventional methods for displaying elements described above in FIG. 1 which require display codes to define characteristics for each element, format identifiers may be employed in the coding of an application. Additionally, instead of requiring program code for specifically providing each of a solid color fill, selection the object, and drawing a rectangular boundary, a format identifier can replace the drawing code. In one embodiment, elements 200-220 of user interface element 200 may each be associated with one or more format identifiers. For example, fill 210 of user interface element 200 is associated with a background fill color for the user interface element. Using a format identifier according to the invention, fill 210 may be coded by a programmer in an exemplary embodiment by:
GetPaintManager( )->Fill_Draw(hDC, FORMATID_TESTFILL, rect.left, rect.top, rect.right, rect.bottom);

Additionally, format identifiers may not be limited to provide just color, but the ability to provide fill an element with backgrounds, gradients, fill patterns, images. According to another embodiment, location and scale of one or more user interface elements 205-220 may further be defined by one or more format identifiers.

According to another embodiment, format identifiers for elements of the user interface application may be specified by a format identifier table. This allows for faster processing, faster programming, and simplifies modification of the user interface elements in application code. Further, modification of one or more user interface elements may be simplified based on the format identifier table. In one exemplary embodiment, the application may include format identifier FORMATID_TESTFILL which may represent a solid blue rectangle during development. At a later time the format identifier may be modified to a red rectangle with a tile image simply by modifying the attributes of the format identifier associated with the format identifier table.

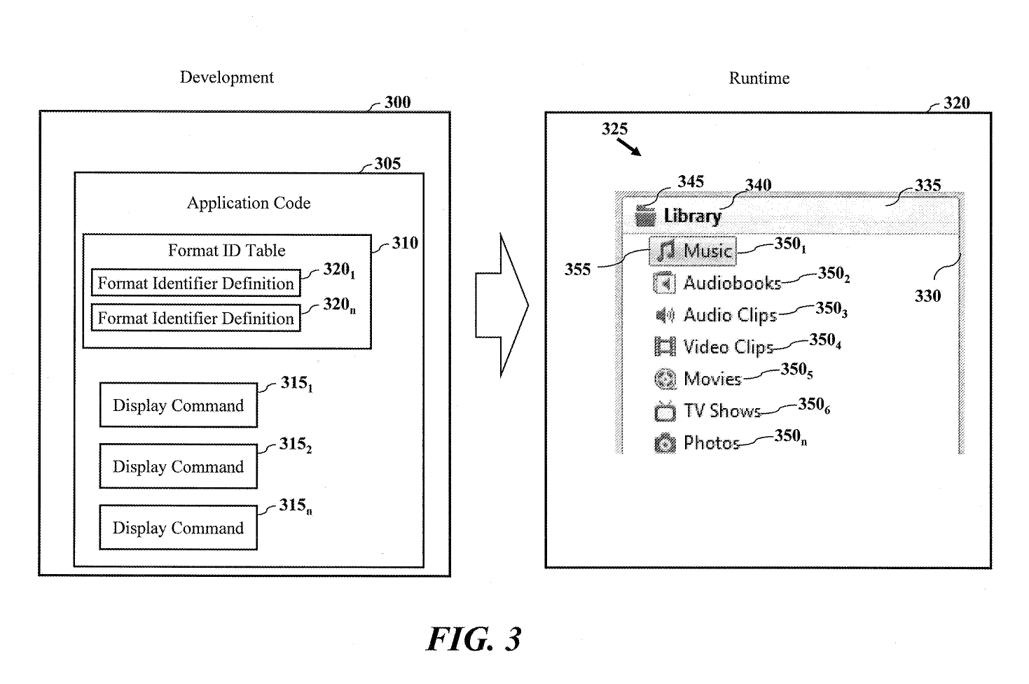

Referring now to FIG. 3, a graphical representation is depicted for display of user interface elements according to one embodiment of the invention. Format identifiers may be beneficial for programmers during development of an application and further, may be advantageous during runtime of the application. Format identifiers may be identified and/or coded during development of an application. Specifically, the format identifier may be coded in association with display commands for one or more user interface elements of an application. Depicted in FIG. 3 is window 300 relating to a window for programming one or more elements of a user interface for an application (e.g., application programming environment). As depicted, window 300 includes code 305 defining operation of an application. Code 305 may include one or more display commands for interface elements, shown as 315₁₋ₙ. Display commands 315₁₋ₙ may relate to paint commands or commands for display visual elements. Display commands 315₁₋ₙ may reference one or more format identifiers in the code. According to one embodiment, interface elements may be defined by and/or associated with one or more format identifiers. Characteristics of format identifiers 320₁₋ₙ of the user interface elements may be provided by format identifier table 310 in code 305. According to one embodiment, attributes of interface elements of code 305 may be modified by modifying elements in the format identifier table 310 according to one embodiment during development. According to another embodiment, one or more format identifiers may be linked, such that characteristics of the format identifiers may be hared by an element.

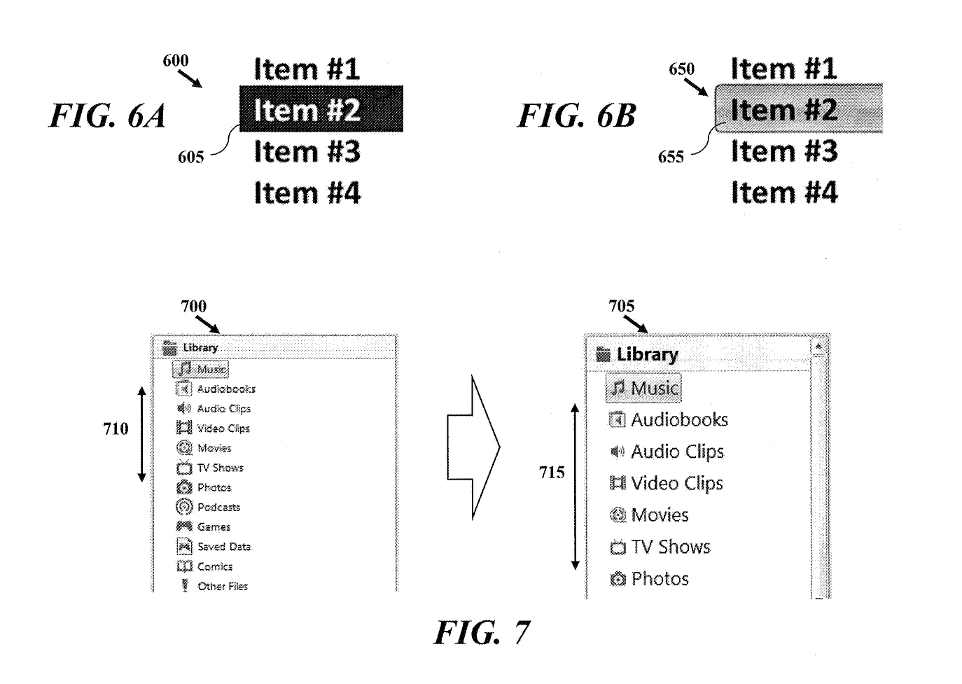

FIG. 3 further depicts a graphical representation of code 305, shown as window 320, during execution of the application by a computing device (e.g., during runtime). Window 320 depicts exemplary output of a display unit provided by an operating platform on a computing device. During execution of the application by the computing device, one or more user interface elements of code 305 may be displayed associated with one or more display commands 315₁₋ₙ. In an exemplary embodiment, interface elements of code 305 can correspond to one or more of user interface elements in window 320, such as user interface element 325. User interface element 325 relates to a menu which may be provided by an application. As depicted in FIG. 3, menu 325 corresponds to a menu of a media application. User interface elements of frame 325 include frame 330, menu bar 335, menu bar text 340, menu bar image 345 and a plurality of sub-elements 350₁₋ₙ. By way of example, a format identifier may provide one of border 330, fill background characteristics of bar 335, font and/or text of menu bar menu 340, image and/or color of menu bar image, and one or more similar attributes of elements in code 305. By way of further example, a format identifier may indicate display of a highlight or colored background for element 350₁ based on user selection, shown as 355. As will be discussed in more detail below with respect to FIGS. 6A-6B, development of menu bar highlighting may be based initially on code of provided with default characteristics and then tailoring for display based on one or more characteristics provided by the format identifier table associated with code 305.

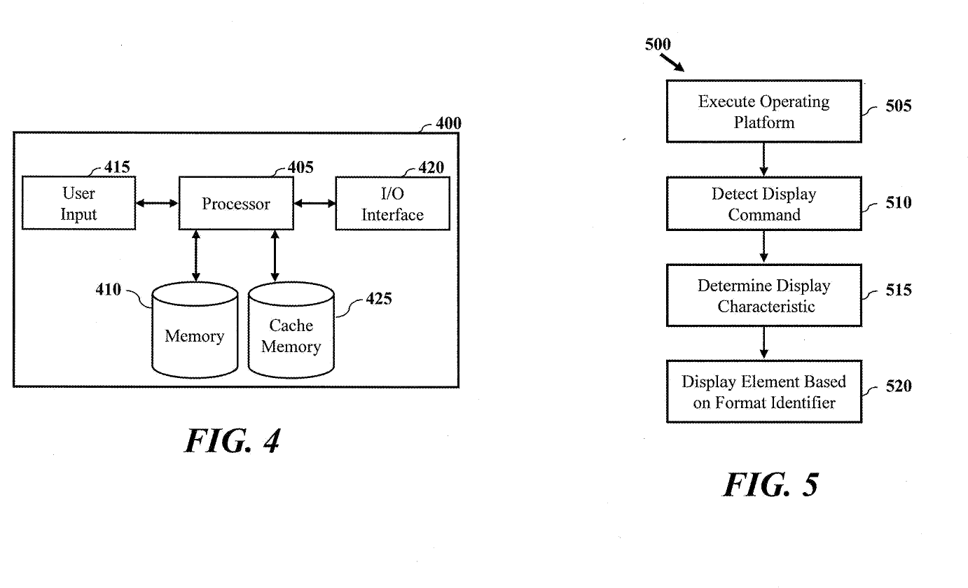

Referring now to FIG. 4, a simplified block diagram is depicted of a computing device according to one or more embodiments of the invention. As shown in FIG. 4, computing device 400 includes processor 405, memory 410, user input 415, input/output (I/O) interface 420 and cache memory 425. Processor 405 may be configured to control operation of computing device 400 based on one or more computer executable code stored in memory 410. For example, processor 405 may be configured to execute code of an operating platform stored in memory 410 and one or more code associated with an application for output one or more display commands to a display. A display may be employed by computing device 400 to display one or more of elements of the application, such as menu functions, user selections, user interface, functions of the application, etc. In one embodiment, display commands may be output via I/O interface 420. In another embodiment, one or more display commands may be output to optional display 430.

In one embodiment, computing device 400 may be employed for coding an application. User input 415 may be configured to provide one or more user commands to processor 450. In one embodiment, processor 405 may be configured to provide a programming interface for a user to develop code for one or more applications. User input 415 of computing device 400 may relate to one or more buttons (e.g., keyboard), a pointing device (e.g., track ball). In that fashion, a user of computing device 400 can code an application including one or more format identifiers. According to another embodiment, processor 405 may be configured to run the applications.

Cache memory 425 may be provided to allow for storage of one or more format identifiers during execution of a program. In one embodiment, the process for displaying based on format identifier may check cache memory for characteristics of one or more display elements in the cache memory when a display command associated with an application is detected. According to another embodiment, an application programming interface (API) may be employed to modify one or more display commands based on characteristics of format identifiers provided by the format identification table. For example, processor 405 may be configured to execute an API to modify one or more display commands in an application program code.

Referring now to FIG. 5, a process is depicted for displaying one or more elements of a user interface according to one or more embodiments of the invention. Process 500 may be initiated by a computing device (e.g., computing device 400) executing an operating platform at block 505. The operating platform may allow for a user interface and one or more applications to be executed for a user of the computing device. Further, execution of an application may include display of one or more user interface elements based on one or more display commands (e.g., user interface element display command 315₁₋ₙ) in the application. Accordingly, process 500 may include checking for display commands in the application by the processor (e.g., processor 305).

Process 500 may include detection of a display command at block 510 and determining a display characteristic at block 515. Display commands detected by process 500 may correspond to display of one or more elements, such as a paint command (e.g., paint command 200) and display of a menu (e.g., menu 325). Determining of the display characteristic may correspond to providing one or more attributes provided by a format identifier table (e.g., format identifier table 310) to the data of the display command for display of an element. One or more display characteristics of the format identifier include one or more of font, text, background format, color, image, graphic style, fill color, outline style, and shape of the element. Format identifier characteristics include one or more of formatting, spacing, position, position relative to another element, position relative to a format identifier, and arrangement of the element. Display commands may be associated with commands of the application executed by the operating platform to display an element associated with one or more of application code, a user input, detection of a device, execution of an application, and selection of the application.

At block 520, the element may be displayed based on one or more format identifiers. Displaying the element can relate to executing the display command based on one or more characteristics of the format identifier, and one or more format identifiers linked to the element. The user interface elements can provide one or more default display characteristics programmed during development and which may be modified by the format identifier table. According to another embodiment, process 500 may include modifying one or more display commands based on characteristics of format identifiers using an API. In one embodiment, the API may be executed using a script, such as XML.

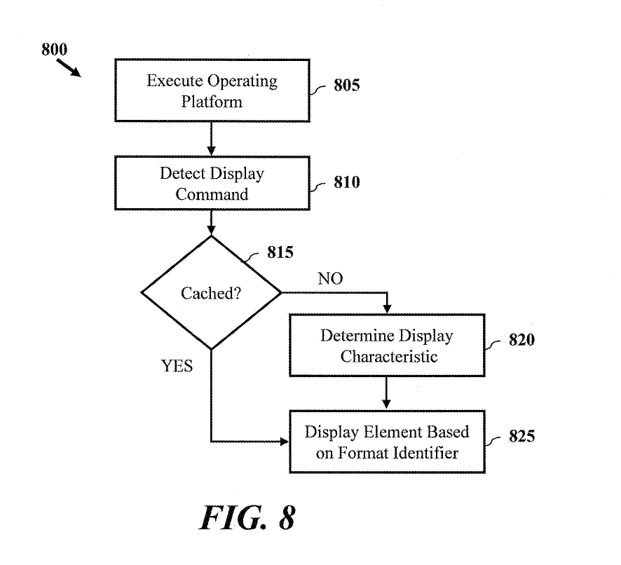

Process 500 may further include repainting one or more user interface elements following display at block 520. Repainting of user interface elements may be based on one or more changes to user interface, such as a user opening or closing a window in the user interface of the operating platform, window resizing, window movement over another window, and a window including animation that require periodical re-painting. According to one embodiment, repainting may be provided based on data stored in cache memory. As will be discussed in more detail below with respect to FIG. 8, one or more characteristics of the element are stored in cache memory of the computing device for a period following display, and wherein display of the element includes determining the characteristics from the cache memory.

Referring now to FIGS. 6A-6B, graphical representations are depicted of user interface elements according to one embodiment of the invention. Format identifiers as disclosed herein may allow for default values to be provided to one or more elements of an application. In that fashion, programmers can run an application during development to view display elements of the application. For example, as depicted in FIG. 6A, list 600 relates to a display command in an application for a list of items including highlighting a particular item, shown as 605. Based on the use of default formatting for the elements, highlighted items may be displayed including fill associated with the element and/or color change. This may be based on default features of the code. In one embodiment, display of elements for the programmer with default features may not require attributes in indentified in the format identifier table. In that fashion, a programmer may check development of code for accuracy, while formatting may be applied for visual appeal based on the format identifiers.

According to another embodiment, during start up of the application or more of the format identifier definitions may be overridden to provide one or more display attributes to the element. Referring now to FIG. 6B, list 650 relates to formatting of the list 600 based on one or more characteristics defined by the format identifier library. As depicted in FIG. 6B, highlighted item 655 is shown including a semi-transparent fill. Although not shown, the format identifier may further define the color of the semi-transparent fill with a gradient and rounded corners. In one embodiment, overwriting of formatting may be employed using XML.

According to another embodiment, format identifiers may provide formatting of scale, position and spacing of one or more user interface elements. Referring now to FIG. 7, a graphical representation is depicted of user interface elements according to one embodiment of the invention. For example, list element 700 is shown based on a first scale, shown as 710, and position for one or more elements. Based on one or more characteristics that may be defined by the format identifier table, the scale and position of menu 700 may be adjusted as shown by menu 705. As depicted, menu 705 includes user interface elements of menu 700 that are enlarged. Scaling of user interface elements may retain positioning while allowing for scale to increase, shown as 715. Because the elements are adjusted based on the format identifier, the invention advantageously allows for formatting of the application without manipulation of code provided by the programmer.

FIG. 8 depicts another process for displaying one or more elements of a user interface according to one or more embodiments of the invention. According to one embodiment, a programming scheme and application code are desired which can accommodate refresh rates associated with an operating platform of a computing device. In contrast to singular loading of code for user interface elements, such as web based applications, an application including format identifiers as described herein can provide code segments which can be loaded and displayed, and allow for repeating of display elements based on changes to the user interface of the computing device. As discussed herein, format identifiers allow for providing one or more attributes that simplify coding and accommodate a plurality of paint commands. Process 800 depicts a process to further allow for optimal refresh periods associated with operating platform. Process 800 may include determining one or more display characteristics for one or more user elements based on cached values associated with format identifier. For example, a computing device (e.g., computing device 400) may store or more format identifier characteristics in cache memory (e.g., cache memory 425) to reduce processing time associated with display of one or more elements. In particular, process 800 may provide overall window caching.

Process 800 may be initiated by executing an operating platform of a computing device at block 805. As will be discussed below, execution of the operating platform may include storing a display window image in cache memory. Process 800 may detect a display command at block 810 based on a particular application executed by the computing device. Each instance a display (e.g., paint) command is detected, one or more elements associated with the command must be displayed for the application. As discussed above, display commands may be based on one or more format identifiers and code for each element. However, according to one embodiment, process 800 may include updating the display with an exact cached copy (e.g., bitmap image) of a previously displayed window when a display command would not result in changes to the display window. For example, when a display command detected at block 810 would not result in visual changes to display elements of a current window, the display window may be refreshed based on a cached copy of the previous display.

Based on a detected display command, the computing device may check cache memory to determine if one or more attributes are stored and/or whether the display command will result in changes to the display window at decision block 815. When cache memory does not include format identifier data and/or the display command would result in changes to the display window (“NO” path out of decision block 815), the computing device may determine one or more display characteristics of the element at block 820. The process may then display the element based on the format identifier data at block 825. When the display command does not result in changes to the display window and one or more of format identifier data and a display window is cached (“YES” path out of decision block 815), the display device may then display the element based on cached at block 825. As a result, overall window caching may be provided. Displaying one or more elements including cached format identifier characteristics can decrease delay in presenting the user interface.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A method for operating a computing device having a processor and a memory storing code to display a user interface for an application, the method comprising the acts of:
executing, by the processor, code of an application program stored in the memory to display a user interface on the computing device;
detecting a display command in the code for an element of the user interface during execution of the application program, wherein the display command identifies a format identifier for the element;
determining one or more display characteristics of the element based on the format identifier, wherein the code include a format identifier table defining one or more display characteristics of the format identifier; and
displaying the element by the computing device, wherein display includes data from the display command based on the one or more characteristics of the format identifier determined from the format identifier table.

2. The method of claim 1, wherein executing the application program includes checking for display commands associated with the application program following an initial display of the user interface.

3. The method of claim 1, wherein the display command relates to a command of the application executed by the operating platform to display an element associated with one or more of application code, a user input, detection of a device, execution of an application, and selection of the application.

4. The method of claim 1, wherein the format identifier relates to a coded description of a user interface element, wherein characteristics of the format identifier are provided by a file identifier table defined in the application program.

5. The method of claim 1, wherein the one or more display characteristics of the format identifier include one or more of font, text, background format, color, image, graphic style, fill color, outline style, and shape of the element.

6. The method of claim 1, wherein the one or more format identifier characteristics include one or more of formatting, spacing, position, position relative to another element, position relative to a format identifier, and arrangement of the element.

7. The method of claim 1, wherein the format identifier table defines format identifier characteristics for a plurality of format identifiers and identifies one or more format identifiers linked to an element.

8. The method of claim 1, wherein the format identifier is linked to one or more of another format identifier and format identifiers of the same type.

9. The method of claim 8, wherein displaying the element relates to executing the display command based on one or more characteristics of the format identifier and one or more format identifiers linked to the element.

10. The method of claim 1, wherein the element provides one or more default display characteristics programmed during development and which may be modified by the format identifier table.

11. The method of claim 1, wherein the one or more characteristics of the element are stored in cache memory of the computing device for a period following display of the element, and wherein subsequent display of the element includes determining the characteristics from the cache memory.

12. A computing device configured to display a user interface for an application, the display device comprising:
a display;
a memory; and
a processor coupled to the display and memory, the processor configured to
execute code of an application program stored in the memory to display a user interface on the computing device;
detect a display command in the code for an element of the user interface during execution of the application program, wherein the display command identifies a format identifier for the element;
determine one or more display characteristics of the element based on the format identifier, wherein the code include a format identifier table defining one or more display characteristics of the format identifier; and
control the display to display the element, wherein display includes data from the display command modified based on the one or more characteristics of the format identifier determined from the format identifier table.

13. The computing device of claim 12, wherein the processor is further configured to check for display commands associated with the application program following an initial display of the user interface during execution of the operating platform.

14. The computing device of claim 12, wherein the display command relates to a command of the application executed by the operating platform to display an element associated with one or more of application code, a user input, detection of a device, execution of an application, and selection of the application.

15. The computing device of claim 12, wherein the format identifier relates to a coded description of a user interface element, wherein characteristics of the format identifier are provided by a file identifier table defined in the application program.

16. The computing device of claim 12, wherein the one or more display characteristics of the format identifier include one or more of font, text, background format, color, image, graphic style, fill color, outline style, and shape of the element.

17. The computing device of claim 12, wherein the one or more format identifier characteristics include one or more of formatting, spacing, position, position relative to another element, position relative to a format identifier, and arrangement of the element.

18. The computing device of claim 12, wherein the format identifier table defines format identifier characteristics for a plurality of format identifiers and identifies one or more format identifiers linked to an element.

19. The computing device of claim 12, wherein the format identifier is linked to one or more of another format identifier and format identifiers of the same type.

20. The computing device of claim 19, wherein processor is configured to display the element by executing the display command based on one or more characteristics of the format identifier and one or more format identifiers linked to the element.

21. The computing device of claim 12, wherein the element provides one or more default display characteristics programmed during development and which may be modified by the format identifier table.

22. The computing device of claim 12, wherein the memory includes cache memory configured to store one or more characteristics of the element for a period following display of the element, and wherein subsequent display of the element includes determining the characteristics from the cache memory.

23. A computer program product comprising a computer readable medium encoded with computer executable code to display a user interface for an application, the computer program product comprising:
computer executable code to execute code of an application program stored in the memory to display a user interface on the computing device;
computer executable code to detect a display command in the code for an element of the user interface during execution of the application program, wherein the display command identifies a format identifier for the element;
computer executable code to determine one or more display characteristics of the element based on the format identifier, wherein the application program code includes a format identifier table defining one or more display characteristics of the format identifier; and
computer executable code to control the display to display the element, wherein display includes data from the display command modified based on the one or more characteristics of the format identifier determined from the format identifier table.

24. The computer program product of claim 23, wherein computer executable code to execute the application program comprises computer executable code to check for display commands associated with the application program following an initial display of the user interface during execution of the operating platform.

25. The computer program product of claim 23, wherein the display command relates to a command of the application executed by the operating platform to display an element associated with one or more of application code, a user input, detection of a device, execution of an application, and selection of the application.

26. The computer program product of claim 23, wherein the format identifier relates to a coded description of a user interface element, wherein characteristics of the format identifier are provided by a file identifier table defined in the application program.

27. The computer program product of claim 23, wherein the one or more display characteristics of the format identifier include one or more of font, text, background format, color, image, graphic style, fill color, outline style, and shape of the element.

28. The computer program product of claim 23, wherein the one or more format identifier characteristics include one or more of formatting, spacing, position, position relative to another element, position relative to a format identifier, and arrangement of the element.

29. The computer program product of claim 23, wherein the format identifier table defines format identifier characteristics for a plurality of format identifiers and identifies one or more format identifiers linked to an element.

30. The computer program product of claim 23, wherein the format identifier is linked to one or more of another format identifier and format identifiers of the same type.

31. The computer program product of claim 30, wherein computer executable code to display the element comprises computer executable code to execute the display command based on one or more characteristics of the format identifier and one or more format identifiers linked to the element.

32. The computer program product of claim 23, wherein the element provides one or more default display characteristics programmed during development and which may be modified by the format identifier table.

33. The computer program product of claim 23, wherein the memory includes cache memory configured to store one or more characteristics of the element for a period following display of the element, and wherein subsequent display of the element includes determining the characteristics from the cache memory.
